(19) United States
(12) Patent Application Publication
(10) Pub. No.: US 2019/0213627 A1
(43) Pub. Date: Jul. 11, 2019

(54) Dynamic Generation Of Live Event In Live Video

(71) Applicant: Connekt Colorado, Inc., Denver, CO (US)

(72) Inventors: David Rudnick, Denver, CO (US); Michael Fitzsimmons, Diablo, CA (US); Michael O'Donnell, Hoboken, NJ (US); Josh Hamann, Denver, CO (US); Christopher Lee, Denver, CO (US)

(21) Appl. No.: 16/240,661

(22) Filed: Jan. 4, 2019

Related U.S. Application Data
(60) Provisional application No. 62/614,222, filed on Jan. 5, 2018.

(51) Int. Cl. G06Q 30/02; H04N 21/234; G06Q 30/08

(52) U.S. Cl. CPC G06Q 30/0244; H04N 21/23424; G06Q 30/08; G06Q 30/0201; G06Q 30/0277

(57) ABSTRACT

In some embodiments, a method receives social data, video data, and/or statistical data for a live video being played and generates an event based on analyzing at least one of the social data, the video data, and the statistical data. The method then classifies the social data into a social score, the video data into a video score, and the statistical data into a statistical score and generates a threshold for the social score, the video score, and the statistical score. When the threshold is met using one or more of the social score, video score, and the statistical score, the event for the live video is triggered where an occurrence of the event is not predetermined for the live video. The method causes an action to be performed during the live video based on the triggering of the event.

### CROSS REFERENCE TO RELATED APPLICATIONS

Pursuant to 35 U.S.C. § 119(e), this application is entitled to and claims the benefit of the filing date of U.S. Provisional App. No. 62/614,222 filed Jan. 5, 2018, the content of which is incorporated herein by reference in its entirety for all purposes.

### BACKGROUND

During video broadcasts, such as live video broadcasts, advertisements may be shown during advertisement breaks. In some examples, the advertisements are pre-set before the video is aired. The pre-set advertisements limit the flexibility for ad providers because once the advertisements are set, no changes can be made.

Dynamic ad insertion may allow a service provider to dynamically select which advertisements may be displayed during ad breaks. For example, the service provider may analyze user characteristics to determine which advertisements may be most relevant to the current user viewing the video. This may improve the advertisements sent to users because more relevant advertisements may be sent to what the service provider believes is each user's preference. However, the service provider is limited to the user characteristics that the service provider can collect when selecting the advertisements.

### BRIEF DESCRIPTION OF THE DRAWINGS

FIG. 1 depicts a simplified system of a method for identifying events in a video in real-time according to some embodiments.

FIG. 2 depicts a more detailed example of an event generator according to some embodiments.

FIG. 3 depicts a simplified flowchart of a method for identifying events according to some embodiments.

FIG. 4 depicts a more detailed example of selecting an actionable event that meets the threshold according to some embodiments.

FIG. 5 depicts a graph showing the event generation according to some embodiments.

FIG. 6 depicts an example of an interface according to some embodiments.

FIG. 7 illustrates an example of special purpose computer systems configured with a video system architecture according to one embodiment.

### DETAILED DESCRIPTION

Described herein are techniques for video system. In the following description, for purposes of explanation, numerous examples and specific details are set forth in order to provide a thorough understanding of some embodiments. Some embodiments as defined by the claims may include some or all of the features in these examples alone or in combination with other features described below, and may further include modifications and equivalents of the features and concepts described herein.

During a video, such as a live video or a traditional prerecorded program, a system can identify environmental events that may be occurring in real-time. The identified event and the time it occurred may not be pre-determined beforehand. In some examples, in live videos of shows, certain events may occur that may elevate excitement and interest in the show. For example, a player may be approaching a career high in points, a golfer may score a hole in one, or an actor may win an award for a movie. These events may not be predictable due to the unscripted nature of the show, such as game play in a sporting event is not predictable. The system includes a novel process to create live events by analyzing data elements associated with the show. For example, the system can determine when a threshold is reached for the event, such as an excitement level is reached for the event. A context associated with the event may be determined for the event. The context may describe what event is occurring in the live video. When the threshold is reached, the system can initiate different actions, such as a real-time bidding engine may allow advertisers to bid and purchase advertisements in real-time based on the detected event. This increases the value for the advertisers as it may be more likely that more people are watching and are excited about the live video and also the advertiser's products may be more relevant to the event that is occurring in the video.

Because the video may be live, the system may not be able to pre-determine live events that may occur and when the live events may occur. The system uses data elements related to the video to determine when a live event may be occurring or has occurred in the live video. For example, the data elements may include, but not limited to, social media data, video data, and statistical data. In some embodiments, the system may classify the social media data, video data, and statistical data into a social media score, a video score, and a statistical score. Then, the system then determines when a live event may be occurring. For example, the system may use the social media data, the video data, and the statistical data to determine an event that may be occurring and also a threshold that can be used to trigger an occurrence (e.g., an imminent future occurrence) of the live event. In some embodiments, the system may aggregate the scores into an aggregated score and then compare the aggregated score to the threshold. It is also possible that a single score, such as a social media score, may also meet the threshold. Either of the above combinations may then trigger an actionable event when the threshold is met.

Once the threshold is met, then the system may trigger an action, such as real-time bidding for providing content (e.g., an advertisement) in a future ad opportunity for the actionable event. The real-time bidding may be associated with the context of the event, such as being related to the context. By identifying actionable events that may be occurring, the system improves the ad decision process. For example, the system first identifies events in the live video that are not predetermined. Then, users may be provided more relevant advertisements based on the live occurrence of events. Because it can be impossible to determine how a live video may develop, the system uses classification logic that analyzes the data elements to generate actionable events automatically. Accordingly, not only is dynamic content selection allowed, the content selected may be more related to actionable events that are occurring in the live video.

System Overview

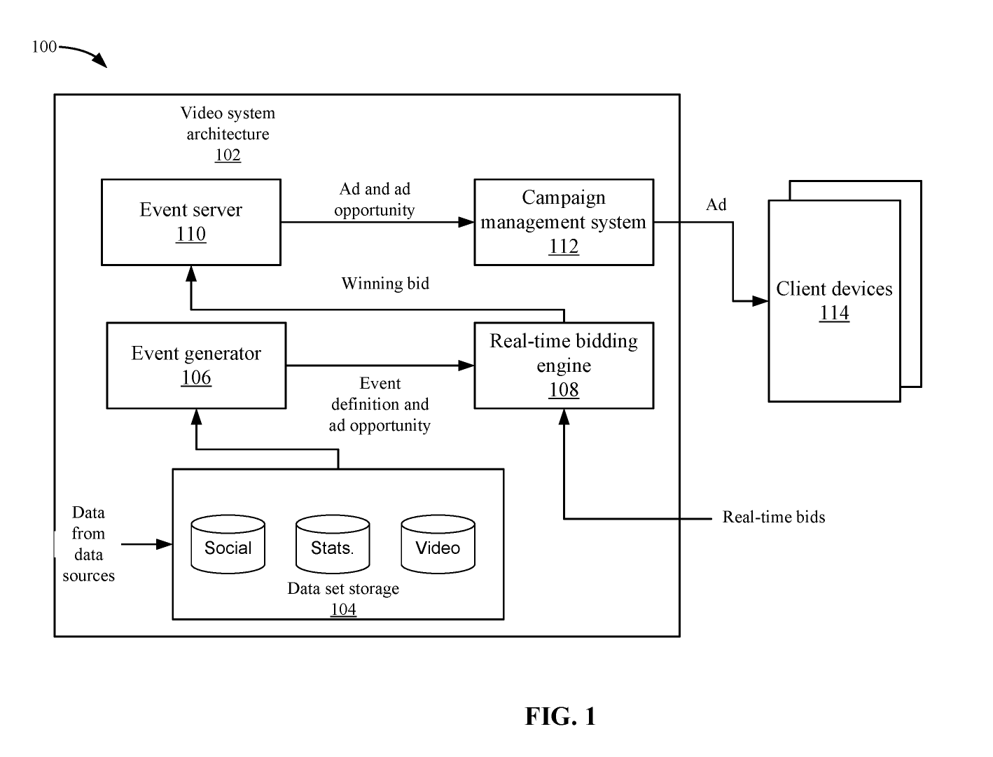

FIG. 1 depicts a simplified system 100 of a method for identifying events in a video in real-time according to some embodiments. System 100 includes video system architecture 102 and client devices 114. Video system architecture 102 may coordinate sending content to client devices 114, such as advertisements, while the users are watching videos on client devices 114.

Video system architecture 102 may include multiple computing devices, such as servers and computation engines. It will be understood that video system architecture 102 may be implemented on one or more computing devices and the functions described may be distributed among multiple computing devices. Client devices 114 include display devices that can display videos, such as televisions, mobile phones, tablet devices, laptop computers, etc. Additionally, client devices 114 may include other devices that may enable the receiving and displaying of videos, such as set top boxes and other receivers.

Video system architecture 102 includes an event generator 106 that is configured to identify events in a video. The live video may be a video that is not pre-recorded before airing (however there may be a small tape delay before broadcast). Examples of live videos include sporting events, concerts, speeches, awards programs (e.g., Oscars, Grammys), parades, etc. Event generator 106 may include logic that classifies data elements and generates scores for each data element. In some embodiments, event generator 106 may include machine learning logic (e.g., artificial intelligence (AI) logic) that may include models to classify data. Event generator 106 uses the scores to identify events that may be occurring or about to occur in the live video.

The data for a video may be received from data sources and stored in data set storage 104. For example, data set storage 104 may include different environmental data that can be classified into different categories, such as social data, video data statistical data, and geographic data. The social data may be received from social media sites, such as real-time messaging sites. The video data may include data that is being displayed in the video. Also, the video data may include data about what program is being viewed by users. The statistical data may include statistics from the event. Examples of social data include real-time messaging data and a social media newsfeed. Examples of video data include visual systems, visitor ratings, and audio systems. The visual systems may be video that is being displayed; the visitor ratings may be how many users are watching the video currently; and audio systems may be audio from the video. Also, the video data may include metadata about which program is being viewed, such as network or content provider, program, episode, cast and crew, etc. The statistical data may include scores from the live event, an event feed, and other stats. The geographical data may be location information for the video or the users, such as the location of the game or where a user is watching the game.

The above data may be real-time data that is received during the live video and also historical data that has been collected previously (e.g., player statistics). Further, event generator 106 may process the data and then return the data to data set storage 104 as processed data. For example, the processed data may include managed data, engagement data, and consumer data that may form new data sets based upon processing of data by event generator 106.

Event generator 106 may classify the social data, video data, and statistical data into separate social media scores, video scores, and statistical scores. Further, event generator 106 may generate a threshold for an event that may be occurring in the video. This threshold event may vary based on information related to the video, such as the program, an event, the viewership of the program, and third party data. When the threshold is met, then event generator 106 may output an event definition for a live event that can be matched to an ad opportunity. For example, if a sporting event is being watched, certain game play in the sporting event may occur that may raise the excitement level of the sporting event, such as a team may be about to win a championship. Event generator 106 may identify the event, and then use the social data, video data, and statistical data to rate the event in terms of the social score, the video score, and the statistical score. Also, event generator 106 may generate a threshold for the event. Event generator 106 may generate the threshold based on a combination of the social media data, the video data, and the statistical data. Scores that reach a particular threshold use static or machine learning models to shift threshold amounts depending on program, event and environmental factors. For example, a sports event may have a algorithm for a no hitter event and a different one for a triple double event. These thresholds may shift based on popularity of the player and use a normalization of a popularity index to baseline players, sports and events. The thresholds may also skew based on local, regional, national, international, and addressable and personalized models.

Then, when a combination of one or more of the social score, the video score, and the statistical score meets the threshold, event generator 106 may determine that an actionable event has occurred and can be matched to an ad opportunity in the future. In some embodiments, the aggregate score of the social score, the video score, and the statistical score may meet the threshold. In other embodiments, a single score, such as the social media score, may meet the threshold. Using indexes for events, each environmental factor of social data, video data, statistical data, or geographical individually or as a group may combine to trigger the event. For example, the social media score may be high enough that the threshold is met by just the social score to generate the actionable event.

Once triggering an actionable event, event generator 106 may perform an action, such as outputting an event definition and an ad opportunity. The event definition may describe a context of the event that is occurring and the ad opportunity might identify an ad slot in which an advertisement can be inserted in the future during the video or identify a time when an interactive element may be displayed on the screen where the video is being viewed. The event definition may include tags of items that can be used to identify possible bidders for the ad opportunity. For example, event generator 106 uses the social media data, the video data, and the statistical data to identify objects or entities associated with the actionable event in the live video. The objects may include, but are not limited to, athletes/players, shoes, other apparel, tickets, consumer products, etc. For example, if a player is approaching a career high, event generator 106 determines sponsorships by the player. These objects are stored in data tables and then via direct or contextual association are made available to event generator 106 to be matched for presentation once an event is determined. In addition the system may use a probability index to select the most relevant ad for the opportunity for a single advertiser in lieu of three competing bidders for a real-time bidding experience.

Real-time bidding engine 108 can then solicit real-time bids from advertisers for the ad opportunity. Real-time bidding engine 108 may solicit bids from advertisers that may be relevant to the event, such as from advertisers for objects that were tagged. For example, if a sporting event is occurring, and a team is about to win the championship, then advertisers that may make apparel of the winning team may be solicited.

Real-time bidding engine 108 may then receive the real-time bids and then select the winning bid. Although real-time bidding is described, other actions may be performed, such as dynamically selecting advertisements for the event. An event server 110 may then retrieve the advertisement, or generate a new advertisement, and provide the advertisement and the identification of the ad opportunity to the campaign management system 112. Campaign management system 112 can then serve the advertisement during the ad opportunity to client devices 114. The system may provide the advertisement in the video, and or reduce the size of the video window and introduce information adjacent to the video.

Classification Process

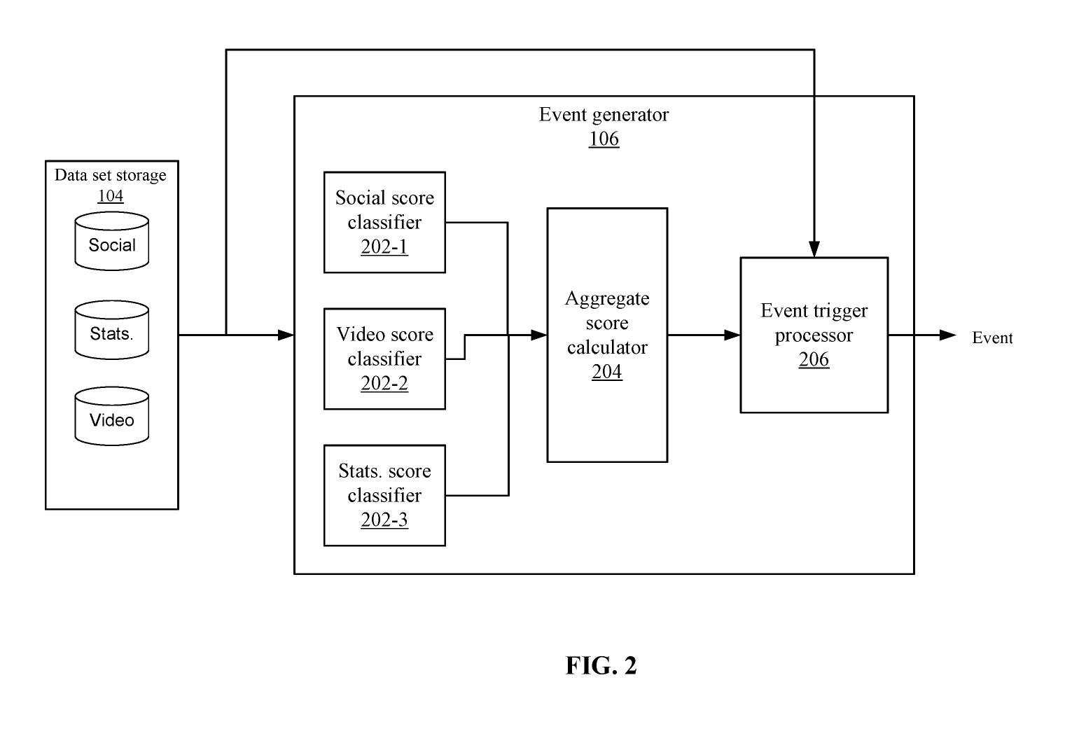

FIG. 2 depicts a more detailed example of event generator 106 according to some embodiments. Event generator 106 includes a social score classifier 202-1, a video score classifier 202-2, and a statistical (Stats) score classifier 202-3. This data is compiled into a mathematical model to calculate a score that will then be related to a threshold. A threshold is determined as an event that may be statistically calculated via a model.

Although these three classifiers are shown, it will be understood that other classifiers may be used. For example, a single classifier may determine multiple scores, such as both the social score and video score. For video programs airing, event generator 106 determines program names and associated program metadata. For example movies have title, name, characters, actors, and other relevant data. This data can be matched by other datasets. Those datasets provide keys to match to other data such as a social media feed for the same or related areas.

Classifiers 202-1 to 202-3 may include algorithms that can classify the individual social data, video data, and statistical data, respectively, into separate scores. The separate scores may be generated because they may hold indicators that machine learning systems can utilize. Generating the individual scores may provide advantages, such as refining scope of events, geography, and personalized based information. The scores may be generated for different events that may be occurring. For example, multiple algorithms may be based on certain events that may occur. For a sporting event, a high score event for the game, an individual high score event, and a triple double or other statistical events may have separate algorithms.

An aggregate score calculator 204 may calculate an aggregate score from the social score, the video score, and the statistical score. In some embodiments, aggregate score calculator 204 weights the social score, the video score, and the statistical score equally to determine the aggregate score. In other embodiments, aggregate score calculator 204 may also include algorithms that may use the importance of the scores to generate the aggregate score. For example, aggregate score calculator 204 may determine that the social media score may be more important and weight that score more heavily in the aggregate score. In some embodiments, the social media data may be more indicative of the event or may describe the event in more detail, such as there may be a higher presence of people sending real-time messages.

An event trigger processor 206 determines when a threshold is met for an event. In some embodiments, event trigger processor 206 may receive the social data, the video data, and the statistical data and generate a threshold for the event. The threshold may be met by either a single score or a combination of the scores. For example, event trigger processor 206 may compare the aggregate score or the individual scores to a threshold to determine when the threshold is met. Also, event trigger processor 206 may compare one of the social score, the video score, and the statistical score to a threshold to determine when the threshold is met.

Event trigger processor 206 may calculate the thresholds by numerically associating values based on data from the algorithm of the event. When a threshold is met, event trigger processor 206 may then trigger an actionable event.

Event Identification and Selection

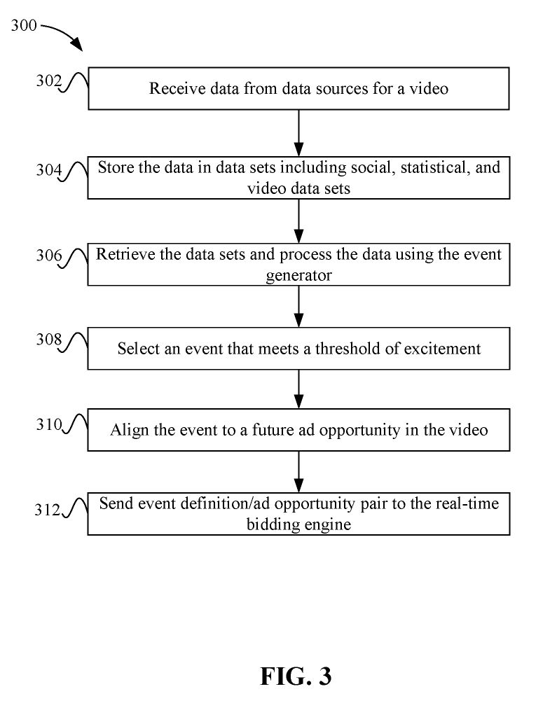

The following describes a general description of determining actionable events that may be occurring in a live video according to some embodiments. FIG. 3 depicts a simplified flowchart 300 of a method for identifying events according to some embodiments. At 302, video system architecture 102 receives data from data sources for a video. At 304, video system architecture 102 stores the data in data sets including, but not limited to, a social data set, a video data set, and a statistical data set. For example, video system architecture 102 may determine where to store the data based on the data source or metadata associated with the data. Further, video system architecture 102 may store different data sets for different videos. For example, real-time messages or notifications that mention or include data that is relevant to a sporting event are associated with a video for the sporting event.

At 306, event generator 106 retrieves the data sets for a video and processes the data. Event generator 106 may select the data sets based on the video program, the event, or other contextual information.

At 308, event generator 106 generates events. Various data types that are associated with a sporting event can be analyzed and computed in real-time to determine events that may be occurring. For example, if a quarterback is closing in on the all-time passing record, the combination of social data (trending), statistical data (number of yards necessary to break the record) and the video data (what is occurring in the video or information about the video) indicate that an actionable moment has occurred or is about to occur.

In some embodiments, event generator 106 identifies a corpus or collection of words that describe the context of the video, such as on the program being broadcast. These descriptors may include cast names, team names for the sports competition in question. Event generator 106 can use the words to compare to the social, statistical, and video data in real-time. Event generator 106 may create a context of the event using the words and also can create further context via Machine Learning and Natural Language Processing techniques (including, but not limited to) TF-IDF (Term Frequency, Inverse Document Frequency), stop word removal, stemming, and turning these words into vectors which can then allow similar words to be found (e.g., grouping dog, hound, and puppy together, and cat, kitten, cat toy together). The context is used to identify the event that may be occurring.

In some embodiments, starting at the beginning of a video, event generator 106 tracks metrics determined from the social, statistical, and video data, such as three metrics referred to as velocity, acceleration and jerk. The velocity may be the measure of an item over time (e.g., some aspect from the social, statistical, and video data), acceleration is the change in velocity over time, and jerk is the change in acceleration over time (e.g., how quickly the acceleration is). One example of an item being analyzed, may be a number of social media messages being sent about a topic, such as a quarterback reaching a passing yards record.

Using the social media messages as an example, the message velocity may be a volume of messages per unit of time (e.g., messages/minute), the message acceleration may be the change in message velocity divided by the change in time (e.g., velocity/time), and message jerk may be the change in message acceleration device by the change in time (e.g., acceleration/time).

After identifying the possible event, determining when the optimal time to trigger an action for the event is difficult. Event generator 106 may determine an optimal time to trigger an action for the event. In some embodiments, event generator 106 generates a threshold and triggers the event when the event meets the threshold. For example, as discussed above, event generator 106 may analyze the social data, the video data, and/or the statistical data to generate a threshold for an event. When that threshold is met by the social score, the video score, and the statistical score, event generator 106 generates an actionable event. In some embodiments, event generator 106 uses the velocity, acceleration, and jerk to determine when the threshold is met. One method for determining the actionable event includes defining an outlier for the metrics of velocity, acceleration, and jerk as the threshold. For example, the threshold may be a deviation from an average, but other methods of setting the threshold may be used. In some embodiments, “X” standard deviations away from the mean may be the threshold, such as “X” is two standard deviations. For example, when the message acceleration moves to two standard deviations away from the mean, the threshold is met for acceleration. In some embodiments, the threshold may be met by all three metrics before an event is selected.

Once an event is determined to be possibly occurring in the future, the messages may be accelerating. However, as the event gets closer, the messages may accelerate even further above the mean, which may meet the threshold. For example, when a quarterback is within 100 yards of the passing record, the possible event may be determined. When the quarterback is within ten yards of the passing recording, the number of messages discussing the passing record may increase enough to meet the velocity threshold. Similarly, the change in tweet velocity may at some point accelerate enough to meet the threshold and the change in acceleration may change enough to meet the threshold. At this point, event generator 106 generates an actionable event.

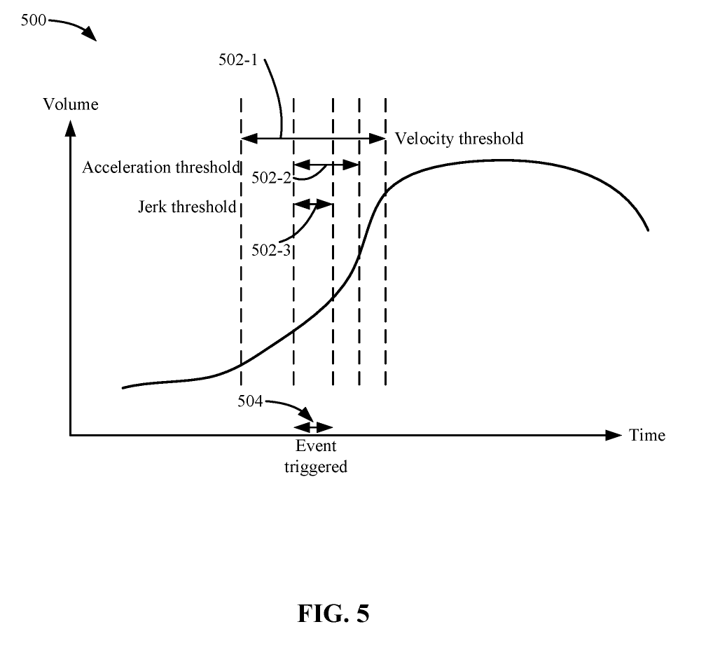

FIG. 5 depicts a graph 500 showing the event generation according to some embodiments. The Y axis represents a volume of messages and the X axis is time. Threshold 502-1 is the velocity threshold, threshold 502-2 is the acceleration threshold, and 502-3 is the jerk threshold. The thresholds may be two standard deviations from the average. When the curve meets all three thresholds, then the event is triggered at 504. The combination of metrics may capture a steepest part of a curve that represents interaction on the social, statistical, and video data. This means the message volume in theory, is not yet at the message volume's highest point (because the message jerk value would slow first, followed by the acceleration, followed by a leveling out of velocity.) In this way event generator 106 can determine the most desirable actionable events as quickly as possible.

When events are not predetermined, it is important to identify events as quickly as possible. Also, in some examples, the event should be identified before it reaches its peak engagement or the event occurs. This is because an advertisement may need to be identified or real-time bidding should occur, which may take some amount of time. If the event is identified when it occurs or after it occurs, then the advertisements may not have the greatest affect. However, if the event can be identified when it is just about reaching its peak, then the action performed for the event may be the greatest. Identifying the point right before the event's peak is difficult because of the unpredictability of the live event. Using the metrics of velocity, acceleration, and jerk allows event generator 106 to identify events at what is considered the best moment in time in an unpredictable live event.

At 310, event generator 106 aligns the actionable event to a future ad opportunity in the video. For example, any upcoming ad opportunity that is available for real-time bidding may be selected. At 312, event generator 106 sends an event definition and ad opportunity pair to real-time bidding engine 108.

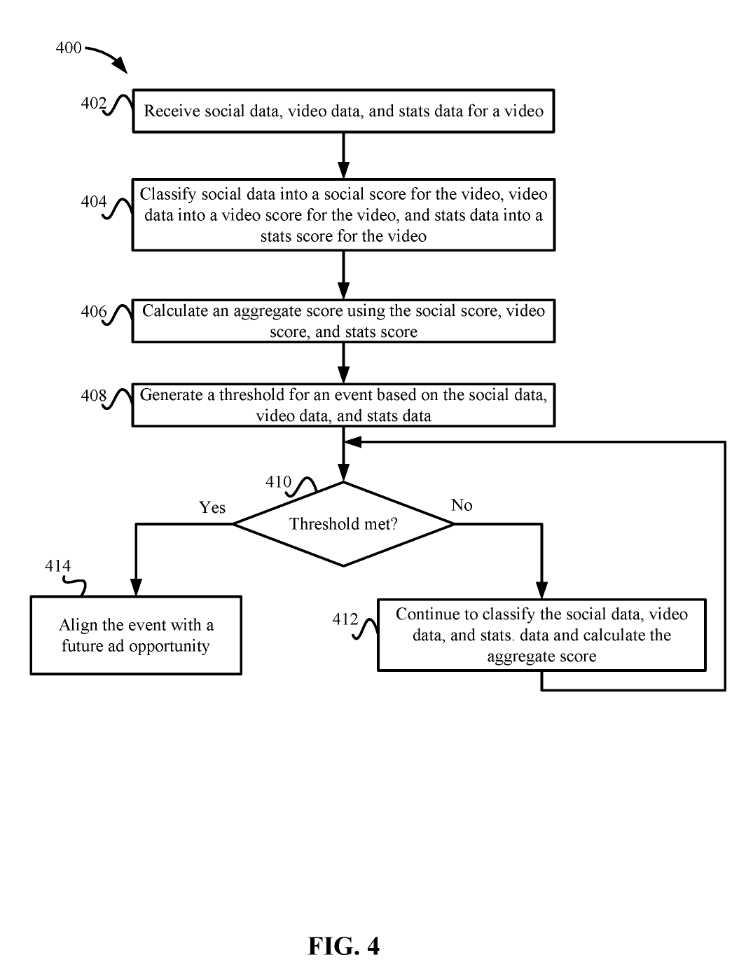

FIG. 4 depicts a more detailed example of selecting an actionable event that meets the threshold according to some embodiments. The threshold is used to quantify a level of excitement in the event, such as users may be more likely to watch or be more interested in a video when the excitement level is higher. At 402, event generator 106 receives the social data, the video data, and the statistical data at respective social score classifier 202-1, video score classifier 202-2, and statistical score classifier 202-3. At 404, social score classifier 202-1, video score classifier 202-2, and statistical score classifier 202-3 classify the social data into a social score for the video, the video data into a video score for the video, and statistical data into a statistical score for the video, respectively. The scores may be for the predetermined events and use the algorithms for each event to generate the scores. At 406, aggregate score calculator 204 calculates an aggregate score using the social score, the video score, and the statistical score.

Then, at 408, event trigger processor 206 generates a threshold for an event based on the social data, the video data, and the statistical data. The threshold may be generated based on algorithms for the predetermined events and may change per video. Also, the threshold may be preset. At 410, event trigger processor 206 determines if the threshold is met. For example, as described above, a single score or a combination of the social score, the video score, and the statistical score may meet the threshold. If the threshold is not met, then at 412, social score classifier 202-1, video score classifier 202-2, and statistical score classifier 202-3 continue to classify the social data, the video data, and the statistical data, and the aggregate score continues to be calculated. Event generator 106 may review the results of events and may adjust thresholds on a go forward basis.

If the threshold is met, then event trigger processor 206 aligns the actionable event with a future ad opportunity. For example, event trigger processor 206 uses an event definition that describes the context of the event to identify related advertisements. Then, event trigger processor 206 outputs the actionable event and the ad opportunity pair. The event may include an event definition that defines the event and also certain items that may be of interest for the live event.

In one example, event generator 106 creates events across any live video, regardless of context. In a football game, all three of the velocity, acceleration, and jerk may reach a threshold at certain points in the game. In one example, event generator 106 identifies an event as a safety when a team is near its own goal line. Then, when the safety occurs, event generator 106 triggers the actionable event. Also, event generator 106 further attributes a context of this event to extract out the specific player who forced the safety, and could use this information to sell particular ad inventory in that moment (maybe a jersey, if the particular context of that program is a sports competition like this one).

Interface

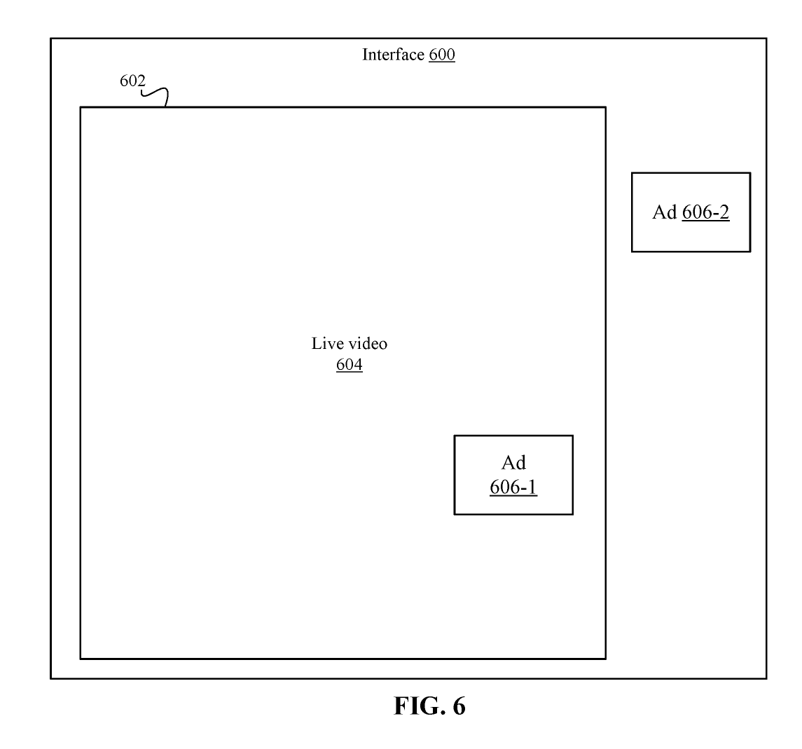

FIG. 6 depicts an example of an interface 600 according to some embodiments. In some examples, the social score, the video score, and the statistical score may be used. Each individual score may be used, such as the social score may be 24, the video score may be “36”, and the statistical score may be “21”. A graph may chart the values of the social score, the video score, and the statistical score over time versus a threshold index. The aggregate score for the social score, the video score, and the statistical score may be compared to the threshold index. In some embodiments, a range from 0-100 may be used, where the threshold is met when the aggregate score reaches 100. However, other ranges may be used.

In some embodiments, the aggregate score may reach the threshold. In this case, the aggregate score from the social score, the video score, and the statistical score may reach 100. In this case, the social score of 90 and the video score of 90 trigger an actionable event. In other examples, the social score may reach 100 and also trigger an event.

The event definition may be based on content associated with the live video. For example, some content may be tagged for the event from within the video according to some embodiments. For example, shoes, athletes, products, and logos may be tagged. Also, event generator 106 may use the social data to identify the tags. The tags identify opportunities for advertisers to bid on an actionable event.

Interface 600 includes an area 602 that displays a live video 604. When an event reaches a threshold, interface 600 may dynamically display an advertisement 606, such as ad 606-1 or ad 606-2. Ad 606-1 may be overlaid into live video 604, such as by tagging an object in live video 604. The tags may include facial recognition tags, object recognition tags, voice recognition tags, audio tags, and logo tags. This information may be extracted from the video. For example, the context of the event may be a player in a football game. Ad 606-1 may be a jersey for the player and is shown next to the player.

Ad 606-2 may be placed in another area of interface 600, such as next to live video 604. The context of ad 606-2 may be the same as ad 606-1 or have content that is different.

The ads may be determined based on bidding positions, such as bidding position #1, bidding position #2, and bidding position #3. The bidding positions may be assigned to different advertisers according to some embodiments. The bidding positions may be determined based on the tags that are selected. For example, a shoe that one of the athletes is wearing is shown in bidding position #1, a jersey for one of teams is shown in bidding position #2, and headphones are shown that are being advertised by one of the athletes playing in the game. The winning bid may then be received from different entities associated with the bidding positions. As shown, bidding position #1 bid the most money and earns the right to advertise in the ad opportunity slot.

### Conclusion

Accordingly, some embodiments can determine events in a live video dynamically. Before a live video starts, there is no way to know what may occur. By using event generator 106, certain events that may occur can be identified without any prior knowledge that the event would occur. To determine these events, certain data is analyzed including the social data, video data, and statistical data. This allows the events that occur in real-time to be identified. Additionally, by calculating a threshold, some embodiments can determine when to trigger an event. The triggering may be performed at a time when the excitement around the event is peaking, which increases the value of the providing some action for the event. For example, this improves the advertisement selection because real-time bidding is only triggered when an event of significance is reached. This frees a company from pre-determining when events occur. Also, the ad system may be simplified because the pre-determination does not need to be programmed.

System

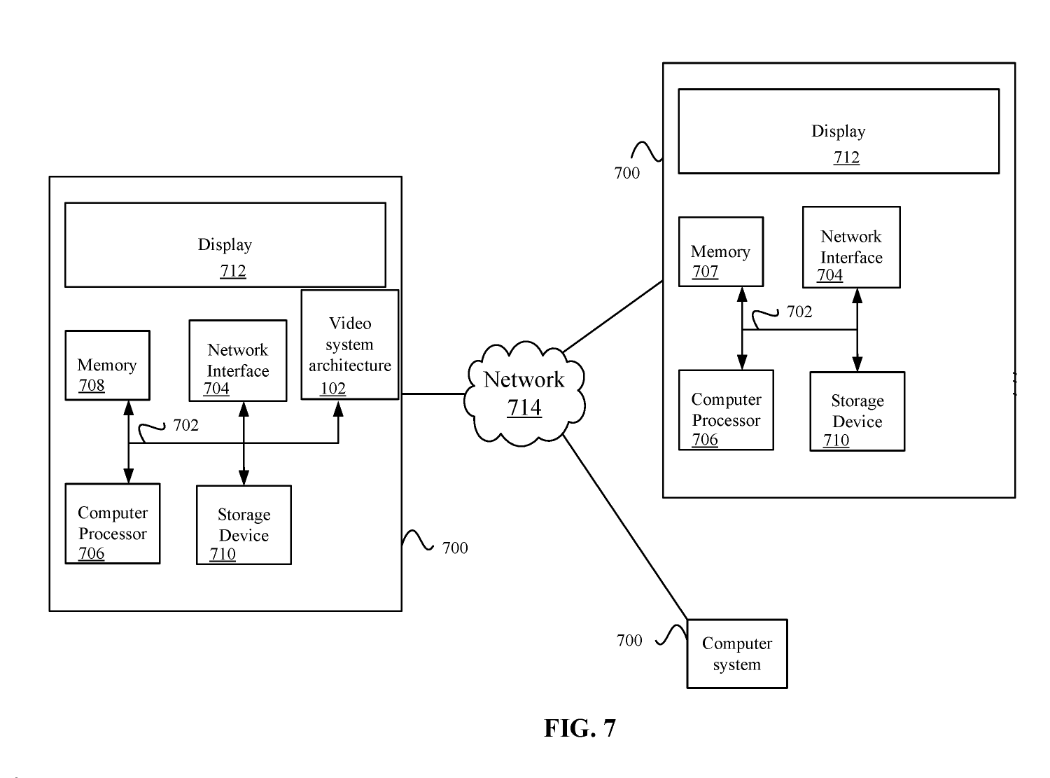

FIG. 7 illustrates an example of special purpose computer systems 700 configured with video system architecture 102 according to one embodiment. Only one instance of computer system 700 will be described for discussion purposes, but it will be recognized that computer system 700 may be implemented for other entities described above, such as client 114.

Computer system 700 includes a bus 702, network interface 704, a computer processor 706, a memory 708, a storage device 710, and a display 712.

Bus 702 may be a communication mechanism for communicating information. Computer processor 706 may execute computer programs stored in memory 708 or storage device 710. Any suitable programming language can be used to implement the routines of some embodiments including C, C++, Java, assembly language, etc. Different programming techniques can be employed such as procedural or object oriented. The routines can execute on a single computer system 700 or multiple computer systems 700. Further, multiple computer processors 706 may be used.

Memory 708 may store instructions, such as source code or binary code, for performing the techniques described above. Memory 708 may also be used for storing variables or other intermediate information during execution of instructions to be executed by processor 706. Examples of memory 708 include random access memory (RAM), read only memory (ROM), or both.

Storage device 710 may also store instructions, such as source code or binary code, for performing the techniques described above. Storage device 710 may additionally store data used and manipulated by computer processor 706. For example, storage device 710 may be a database that is accessed by computer system 700. Other examples of storage device 710 include random access memory (RAM), read only memory (ROM), a hard drive, a magnetic disk, an optical disk, a CD-ROM, a DVD, a flash memory, a USB memory card, or any other medium from which a computer can read.

Memory 708 or storage device 710 may be an example of a non-transitory computer-readable storage medium for use by or in connection with computer system 700. The non-transitory computer-readable storage medium contains instructions for controlling a computer system 700 to be configured to perform functions described by some embodiments. The instructions, when executed by one or more computer processors 706, may be configured to perform that which is described in some embodiments.

Computer system 700 includes a display 712 for displaying information to a computer user. Display 712 may display a user interface used by a user to interact with computer system 700.

Computer system 700 also includes a network interface 704 to provide data communication connection over a network, such as a local area network (LAN) or wide area network (WAN). Wireless networks may also be used. In any such implementation, network interface 704 sends and receives electrical, electromagnetic, or optical signals that carry digital data streams representing various types of information.

Computer system 700 can send and receive information through network interface 704 across a network 714, which may be an Intranet or the Internet. Computer system 700 may interact with other computer systems 700 through network 714. In some examples, client-server communications occur through network 714. Also, implementations of some embodiments may be distributed across computer systems 700 through network 714.

Some embodiments may be implemented in a non-transitory computer-readable storage medium for use by or in connection with the instruction execution system, apparatus, system, or machine. The computer-readable storage medium contains instructions for controlling a computer system to perform a method described by some embodiments. The computer system may include one or more computing devices. The instructions, when executed by one or more computer processors, may be configured to perform that which is described in some embodiments.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of some embodiments may be implemented. The above examples and embodiments should not be deemed to be the only embodiments, and are presented to illustrate the flexibility and advantages of some embodiments as defined by the following claims. Based on the above disclosure and the following claims, other arrangements, embodiments, implementations and equivalents may be employed without departing from the scope hereof as defined by the claims.

What is claimed is:

1. A method comprising:
receiving, by a computing device, at least one of social data, video data, and statistical data for a live video being played;
generating, by the computing device, an event based on analyzing at least one of social data, video data, and statistical data;
classifying, by the computing device, at least one of the social data into a social score, the video data into a video score, and the statistical data into a statistical score;
generating, by the computing device, a threshold for at least one of the social score, the video score, and the statistical score;
when the threshold is met using one or more of the social score, video score, and the statistical score, triggering, by the computing device, the event for the live video, wherein an occurrence of the event is not predetermined for the live video; and
causing, by the computing device, an action to be performed during the live video based on the triggering of the event.

2. The method of claim 1, wherein classifying at least one of the social data into the social score, the video data into the video score, and the statistical data into the statistical score comprises:
calculating one or more metrics for at least one of the social score, the video score, and the statistical score, wherein a change in the one or more metrics is compared to the threshold to trigger the event.

3. The method of claim 1, wherein classifying at least one of the social data into the social score, the video data into the video score, and the statistical data into the statistical score comprises:
calculating a velocity, an acceleration, and a jerk for at least one of the social score, the video score, and the statistical score, wherein the velocity is a measure of an item over time, acceleration is a change of the velocity over change in time, and jerk is a change in the acceleration over change in time.

4. The method of claim 3, wherein the measure of the item over time comprises measuring a volume of the item over time.

5. The method of claim 3, wherein the item is associated with at least one of the social data, the video data, and the statistical data for the event.

6. The method of claim 3, wherein using the velocity, the acceleration, and the jerk identify the occurrence of the event before the event occurs in the live video.

7. The method of claim 1, wherein generating the threshold comprises:
using a deviation from an average for the one or more of the social score, video score, and the statistical score.

8. The method of claim 7, wherein the deviation is preset.

9. The method of claim 7, wherein the deviation is dynamically determined based on at least one of social data, video data, and statistical data.

10. The method of claim 1, wherein generating the threshold comprises:
dynamically determining the threshold based on content from at least one of social data, video data, and statistical data.

11. The method of claim 1, further comprising:
analyzing at least one of at least one of social data, at least one of social data, video data, and at least one of the social data, the video data, and the statistical data statistical data video data, and statistical data social data, video data, and statistical data for the event to extract a context for the event.

12. The method of claim 1, further comprising:
analyzing words from at least one of the social data, the video data, and the statistical data for the event to extract a context for the event.

13. The method of claim 1, wherein causing the action to be performed during the live video based on the context for the event
sending a notification for a real-time bidding engine to solicit bids associated with a plurality of advertisements for an advertisement opportunity for the event.

14. The method of claim 13, further comprising:
receiving one of the plurality of advertisements from the real-time bidding engine.

15. The method of claim 13, wherein the plurality of advertisements are selected based on the context for the event.

16. A non-transitory computer-readable storage medium having stored thereon computer executable instructions, which when executed by a computer device, cause the computer device to be operable for:
receiving at least one of social data, video data, and statistical data for a live video being played;
generating an event based on analyzing at least one of the social data, the video data, and the statistical data;
classifying at least one of the social data into a social score, the video data into a video score, and the statistical data into a statistical score;
generating a threshold for at least one of the social score, the video score, and the statistical score;
when the threshold is met using one or more of the social score, video score, and the statistical score, triggering the event for the live video, wherein an occurrence of the event is not predetermined for the live video; and
causing an action to be performed during the live video based on the triggering of the event.

17. The non-transitory computer-readable storage medium of claim 16, wherein classifying at least one of the social data into the social score, the video data into the video score, and the statistical data into the statistical score comprises:
calculating one or more metrics for at least one of the social score, the video score, and the statistical score, wherein a change in the one or more metrics is compared to the threshold to trigger the event.

18. The non-transitory computer-readable storage medium of claim 16, wherein classifying at least one of the social data into the social score, the video data into the video score, and the statistical data into the statistical score comprises:
calculating a velocity, an acceleration, and a jerk for at least one of the social score, the video score, and the statistical score, wherein the velocity is a measure of an item over time, acceleration is a change of the velocity over change in time, and jerk is a change in the acceleration over change in time.

19. The non-transitory computer-readable storage medium of claim 16, further comprising:
analyzing at least one of the social data, the video data, and the statistical data for the event to extract a context for the event.

20. An apparatus comprising:
one or more computer processors; and
a computer-readable storage medium comprising instructions for controlling the one or more computer processors to be operable for:
receiving at least one of social data, video data, and statistical data for a live video being played;
generating an event based on analyzing at least one of the social data, the video data, and the statistical data;
classifying at least one of the social data into a social score, the video data into a video score, and the statistical data into a statistical score;
generating a threshold for at least one of the social score, the video score, and the statistical score;
when the threshold is met using one or more of the social score, video score, and the statistical score, triggering the event for the live video, wherein an occurrence of the event is not predetermined for the live video; and
causing an action to be performed during the live video based on the triggering of the event.
